(19) United States
(12) Patent Application Publication
(10) Pub. No.: US 2010/0222625 A1
(43) Pub. Date: Sep. 2, 2010

(54) Method for stabilizing heavy metals

(76) Inventor: Hung-Liang Chen, Yonghe City (TW)

Correspondence Address: Jackson Intellectual Property Group PLLC, 106 Starvale Lane, Shipman, VA, 22971, US

(21) Appl. No.: 11/898,799

(22) Filed: Sep. 14, 2007

(51) Int. Cl. A62D 3/00

(52) U.S. Cl. 588/313

(57) ABSTRACT

The invention is a method for stabilizing heavy metals of the fly ash, the bottom ash or the soil. The stabilization agents which belong to silicate materials, was added to fly ash bottom ash or soil by sprinkling or directly subjoining mix and so on. After this reaction, low soluble and stabilize Heavy metal-Silicate compounds which were formed and didn't re-leaching heavy metals easily (especially, Pb) in the nature environment, even leaching results could below the regulated values and fill the reuse regulations

### BACKGROUND OF THE INVENTION

(a) Field of the Invention

The present invention is related to a stabilizing method, and more particularly, to a method to stabilize heavy metals in fly ash, bottom ash or soil by using silicate substance as stabilizer for silicates and ions of soluble silicate radical to form stabilized substances with heavy metals in fly ash, bottom ash, or soil so that the heavy metals, lead in particular, found in the fly ash, bottom ash, or soil to meet leach test standard or reduce or prevent leach under erosion in the natural environment.

(b) Description of the Prior Art

In generally, ash resulted from incineration is comprised of bottom ash and fly ash. Wherein, bottom ashes relate to those residues left on the grate after incineration of the refuses, and are essentially comprised of nonflammable inorganic substances, e.g., glass, sand, and ceramic. Bottom ashes are then wetted and quenched; therefore they have higher water containment, indicate black, present odors, and feature wide distribution coverage of particles. Fly ash is further classified into boiler ash and reaction ash with the former normally produced by particles falling from walls of a boiler when an ash blower is used to blow the boiler and is only produced in massive quantity during the boiler is under routine cleaning; and the later is the fly ash collected by the dust collecting system or scrubber and comprised of particles and heavy metals collected by air pollution control system in an incineration plant that also contain certain reactants and alkalis not reacted.

According to records of containment of heavy metals in bottom ash and fly ash in domestic and foreign documentations, compositions of refuses vary depending on country and living style. The containment of heavy metals in fly ash is generally higher with a leach concentration frequently in excess of the leach test standard specified by EPA of the ROC. Pb and Zn appear to be two types of metal having the highest containment among those records. Therefore, lead, zinc and cadmium are put on the top of the list calling for urgent treatment in the efforts of pursuing hazard-free fly ash.

As provided by the domestic EPA, bottom ash from incineration is classified as one of general industrial refuses, and a substance that can be reused after proper treatment as published by EPA. Fly ash on the contract for containing higher level of leached heavy metals is considered as one of the hazardous industrial refuses. EPA is essentially relied upon NIEAR 201.13 test method (TCLP leach test) to have iced acetic acid solution with a weight twenty times of that of an ash sample to extract ash sample for eighteen hours, the extracted sample is filtered using filter paper, acid digested, and 100 ml of extraction solution is taken to perform heavy metal leach analysis with results to be judge pursuant to specifications of recognition standard of general industrial refuses.

According to survey data available from EPA, a total of approximately fifty thousand hectares, or 5.7% of the total area of survey in Taiwan is found with higher level of heavy metal containment in the soil of farm land in the Taiwan area justifying serious look at the issue of soil contamination and fortify pollution control and prevention works to stop further deterioration of soil quality. Lead-gasoline consumed by vehicles causes exhaust containing lead chemicals, which are washed away by storm water and settled down in the soil resulting in lead pollution, and further entering into human body through the chain or food. Most of fertilizers are of inorganic sales, which are soluble in the soil. Excessive use of chemical fertilizers will cause the soil acidified to affect the growth of agricultural crops.

As taught in U.S. Pat. No. 5,202,033, phosphate, carbonate, and sulfate are added to solid refuses to lower the level of TCLP Pb in heavy metals. U.S. Pat. No. 5,037,479 discloses a method of using a buffer comprised of reactive calcium carbonate and reactive magnesium carbonate containing additives (including slats of negative ions of a group comprised of concentrated superphosphate, ammonium phosphate, di-ammonium phosphate (DAP), phosphoric acid, boric acid, and metallic acid) to be mixed with the refuses for reducing lead leach level in heavy metals. U.S. Pat. No. 4,889,640 teaches a method to lower the level of lead leach from heavy metals by adding group reagent comprised of reactive calcium carbonate, reactive magnesium carbonate, and reactive lime into solid refuses.

However, stimulating and odorous gas products including phosphene can be easily produced by adding phosphoric acid series into bottom ash or fly ash to affect health of the operator. Furthermore, associate process system is vulnerable to be corroded by acidity from phosphoric acid substance, and when added into the contaminated soil, the soil will be readily acidified.

### SUMMARY OF THE INVENTION

The primary purpose of the present invention is to provide a method for stabilizing heavy metals in bottom ash and fly ash from incinerating refuses, or in soil by using silicates to lower the level of leach of heavy metals for making bottom ash, fly ash, or soil free of hazards, and the silicate indicates alkaline, a composition of natural earth and stone and will neutralize pH of the soil when added into ash sludge and soil without causing hazards to the environment.

To achieve the purpose, a method to stabilize heavy metals found in fly ash and bottom ash produced from incinerating refuses or in soil of the present invention involves use of a substance of silicate as a stabilizer, which is added to the bottom ash, fly ash or soil by sprinkling onto or by direct mixing to have the ions of soluble silicate radical in the stabilizer and those heavy metals in the bottom ash, fly ash or soil to form a heavy metal silicate stabilizer in low solubility so that a leach test of heavy metals (and lead particularly) in the bottom ash, fly ash or soil will meet the leach standard of general industrial refuses, and prevent the heavy metals from being easily leached out under erosion of the natural environment. Polluting elements in the soil will react with silicate radicals in the soil to form sediments so to reduce their solubility in the soil. On the other hand, pH of the soil increases thus to reduce solubility for ions of heavy metals to settle down in a stabilized chemical form to effectively reduce absorption of heavy metals by plants. Accordingly, agricultural crops meeting health standard may grow also in soil subject to serious migration and compound pollution by heavy metals.

The silicate salts referred in the present invention include sodium silicate, calcium silicate, silicate sales and their compound chemicals and the agent form is liquid solvent or solid (powder, grain) agent. A stabilizer selected from the silicate salts causes inorganic silicate radical ions to react with heavy metals to form heavy metal silicate salts that are hardly soluble.

### DETAILED DESCRIPTION OF THE PREFERRED EMBODIMENTS

The present invention uses a substance selected from silicate salts as a stabilizer and the stabilizer is added into soil or bottom ash and fly ash resulted from incineration of refuses either by sprinkling or by direct addition. Silicate sales in the stabilizer and its soluble silicate radical ions and heavy metals found in the bottom ash and fly ash or in the soil to from a stabilized substance for the substance to meet leach standard or prevent those heavy metals, particularly lead (Pb) among them, from easy leach by erosion under natural environment so to achieve the purposes of making the bottom ash and the fly ash resulted form incineration of refuses free of hazard and reducing the extent of absorption of heavy metals in polluted soil. In either case, its solubility product (ksp) is lower than 10E-25 (ksp<10⁻²⁵).

Preferred embodiments given below prove results of using the substance selected from silicate salts to reduce leach of heavy metals in the bottom ash, fly ash or the soil.

### A First Preferred Embodiment

Reactive ash and boiler ash from fly ash produced by a certain incineration plant located in northern Taiwan are mixed and directly added respectively into dry sodium silicate and calcium silicate powders, and then mixed either by a mixer or roller and put for TCLP Pb leach analysis. Results as listed in Table 1 indicate the addition of sodium silicate and calcium silicate effectively reduces lead of heavy metal Pb in fly ash.

TABLE 1
Test Results of the 1^{st} Preferred Embodiment

| | | Type of Stabilizer | |
|---|---|---|---|
| | | Added & Addition | |
| | | (by weight) | TCLP-Pb |
| | Sample | vs. 100% of Sample | Leach |
| No. | Matrix | Matrix (by weight) | (mg/L) |
| 1 | Fly Ash | No addition | 40.31 |
| | (Mixed Ash) | | |
| 2 | Fly Ash | Sodium Silicate 0.8% | 30.15 |
| | (Mixed Ash) | | |
| 3 | Fly Ash | Sodium Silicate 4.0% | 14.13 |
| | (Mixed Ash) | | |
| 4 | Fly Ash | Sodium Silicate 8.0% | 4.32 |
| | (Mixed Ash) | | |
| 5 | Fly Ash | Sodium Silicate 16.0% | 2.38 |
| | (Mixed Ash) | | |
| 6 | Fly Ash | Calcium Silicate 0.8% | 28.42 |
| | (Mixed Ash) | | |
| 7 | Fly Ash | Calcium Silicate 4.0% | 12.31 |
| | (Mixed Ash) | | |
| 8 | Fly Ash | Calcium Silicate 8.0% | 6.28 |
| | (Mixed Ash) | | |
| 9 | Fly Ash | Calcium Silicate 12.0% | 4.62 |
| | (Mixed Ash) | | |
| 10 | Fly Ash | Calcium Silicate 16.0% | 3.23 |
| | (Mixed Ash) | | |

Leach of Pb can be effectively achieved by readjusting the containment of silicate salt. It takes only to readjust the addition of sodium silicate up to 8% or higher or addition of calcium silicate up to 12% or higher for compliance with EPA defined hazard free industrial refuses and EPA standard Pb leach level of not greater than 5 mg/L for reuse. In case of other type of silicate salt, the addition must be not less than 10%.

### A Second Preferred Embodiment

Bottom ash from fly ash produced by a certain incineration plant located in northern Taiwan after having survived screening to separate ferrous metals, non-ferrous metals, and substances not incinerated at a sorting plant, is directly added into dry sodium silicate and calcium silicate powders, and then mixed either by a mixer or roller and put for TCLP Pb leach analysis. Results as listed in Table 2 indicate the addition of sodium silicate and calcium silicate effectively reduces lead of heavy metal Pb.

TABLE 2
Test Results of the 2^{nd} Preferred Embodiment

| | | Type of Stabilizer | |
|---|---|---|---|
| | | Added & Addition (by | |
| | | weight) vs. 100% of | TCLP-Pb |
| | | Sample Matrix (by | Leach |
| No. | Sample Matrix | weight) | (mg/L) |
| 1 | Bottom Ash from | No addition | 5.59 |
| | Incineration | | |
| 2 | Bottom Ash from | Sodium Silicate 0.4% | 2.31 |
| | Incineration | | |
| 3 | Bottom Ash from | Sodium Silicate 4.0% | 1.23 |
| | Incineration | | |
| 4 | Bottom Ash from | Sodium Silicate 8.0% | 0.56 |
| | Incineration | | |
| 5 | Bottom Ash from | Sodium Silicate 16.0% | 0.32 |
| | Incineration | | |
| 6 | Bottom Ash from | Calcium Silicate 0.4% | 1.98 |
| | Incineration | | |
| 7 | Bottom Ash from | Calcium Silicate 4.0% | 1.02 |
| | Incineration | | |
| 8 | Bottom Ash from | Calcium Silicate 8.0% | 0.35 |
| | Incineration | | |
| 9 | Bottom Ash from | Calcium Silicate 16.0% | 0.26 |
| | Incineration | | |

Leach of Pb can be effectively achieved by readjusting the containment of silicate salt. It takes only to readjust the addition of sodium silicate up to 0.4% or higher or addition of calcium silicate up to 0.4% or higher for compliance with EPA defined hazard free industrial refuses and EPA standard Pb leach level of not greater than 5 mg/L for reuse.

### A Third Preferred Embodiment

Dry powders of sodium silicate and calcium silicate are respectively added to a soil at a certain area in the northern Taiwan found with higher level of leach of heavy metals. Both types of silicates are added by sprinkling onto a surface layer of the soil; the soil is ploughed using a stump-jump plough so to mix both silicates with the soil before performing the TCLP Pb leach analysis. As indicated by the experiment results as listed in Table 3, addition of sodium silicate and calcium silicate effective lower the leach of heavy metal Pb in the soil.

TABLE 3
Test Results of the 3^{rd} Preferred Embodiment

| | | Type of Stabilizer | |
|---|---|---|---|
| | | Added & Addition (by | |
| | | weight) vs. 100% of | |
| | Sample | Sample Matrix (by | TCLP-Pb |
| No. | Matrix | weight) | Leach (mg/L) |
| 1 | Soil | No addition | 8.98 |
| 2 | Soil | Sodium Silicate 0.8% | 5.23 |
| 3 | Soil | Sodium Silicate 4.0% | 3.28 |
| 4 | Soil | Sodium Silicate 8.0% | 1.25 |
| 5 | Soil | Sodium Silicate 16.0% | 0.92 |
| 6 | Soil | Calcium Silicate 0.8% | 5.34 |
| 7 | Soil | Calcium Silicate 4.0% | 2.85 |
| 8 | Soil | Calcium Silicate 8.0% | 0.96 |
| 9 | soil | Calcium Silicate 16.0% | 0.58 |

Therefore, the level of Pb leach can be effectively reduced by readjusting the containments of silicate salts. Though EPA does not prescribe the level of leach of heavy metal in soil, the addition of silicate salts into the soil helps reduce the level of leach of heavy metal to prevent crops from absorbing leached heavy metal thus to achieve dual purposes of maintaining human health and readjusting pH of the soil.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A method for processing bottom ash and fly ash from incinerated refuses or soil comprising use of a heavy metal stabilizer containing silicate salt to mix with the bottom ash, fly ash or soil either by sprinkling or direct addition.

2. The method for processing bottom ash and fly ash from incinerated refuses or soil as claimed in claim 1, wherein a stabilized heavy metal silicate salt is formed by having silicate salt and its soluble silicate radical ions in the stabilizer to react with heavy metals found in the bottom ash, fly ash, or soil with a Pb leach level lower than 5 mg/L.

3. The method for processing bottom ash and fly ash from incinerated refuses or soil as claimed in claim 1, wherein silicate salt and its soluble silicate radical ions in the stabilizer react with heavy metals found in the bottom ash, fly ash or soil to form a stabilized of heavy metal silicate salt with a solubility product (ksp) lower than 10E-25 (ksp<10⁻²⁵).

4. The method for processing bottom ash and fly ash from incinerated refuses or soil as claimed in claim 1, wherein the stabilizer is selected from sodium silicate, calcium silicate or other silicate salt and any chemical of their combinations.

5. The method for processing bottom ash and fly ash from incinerated refuses or soil as claimed in claim 4, wherein the stabilizer is related to a liquid solvent or solid-state agent under normal temperature and normal pressure.

6. The method for processing bottom ash and fly ash from incinerated refuses or soil as claimed in claim 4, wherein an amount of addition of sodium silicate is not less than 8% by weight or that of calcium silicate is not less than 12% by weight, or that of other silicate salt is not less than 10% by weight in relation to 100% incinerated fly ash by weight.

7. The method for processing bottom ash and fly ash from incinerated refuses or soil as claimed in claim 1, wherein an amount of addition of the stabilizer is not less than 0.4% by weight in relation to 100% incinerated bottom ash by weight.

8. The method for processing bottom ash and fly ash from incinerated refuses or soil as claimed in claim 1, wherein an amount of addition of the stabilizer is not less than 0.8% by weight in relation to 100% soil by weight.
